(19) United States
(12) Patent Application Publication
(10) Pub. No.: US 2017/0237243 A1
(43) Pub. Date: Aug. 17, 2017

(54) CONDUIT GUARD

(71) Applicant: GERALD MACUALAY BREY, Beaumont, CA (US)

(72) Inventor: GERALD MACUALAY BREY, Beaumont, CA (US)

(21) Appl. No.: 15/044,105

(22) Filed: Feb. 15, 2016

(51) Int. Cl. H02G 3/04

(52) U.S. Cl. CPC H02G 3/0406

(57) ABSTRACT

A conduit bushing for cooperation with an associated elongated housing for physical protection of associated telecommunications and/or electric power transmission conductors which includes a generally cylindrical body dimensioned and configured for engagement with the axial extremity of the associated elongated housing. The generally cylindrical body has a peripheral region and a central region. The central region is bounded by the peripheral region. The central region is dimensioned and configured to break away from the peripheral region.

### TECHNICAL FIELD

The present invention is generally directed to apparatus for use in the wiring of buildings as well as between buildings. More particularly, the present invention is directed to conduit for protection of electrical and data runs. Even more particularly, the present invention is directed to apparatus that prevents the entry of foreign objects, referred to herein as debris, from entering such conduits particularly during either construction or modification of such buildings. It will be understood that the present invention has application to both ducts and conduits for protection of power and data cables. For convenience of description the term “conduit” will be understood to be generic to both conduits and ducts.

Both outside plant and in-building communications and power cables are often placed in a conduit. The conduit provides protection from both physical and environmental abuse. In underground installation, conduit protects cable from shifting rocks, aggressive rodents, and/or damage from hand shovels. Underground cable that is in conduit is relatively easy to replace or upgrade. The old cable can be pulled out of the conduit and the new pulled in without extensive and expensive digging.

In metropolitan areas, multiple conduits are often grouped as “duct banks.” Placing cable into empty ducts in these banks allows changes and growth of the building's and/or the city's cable infrastructure without major traffic disruptions from cutting and trenching of the street.

A large percent of underground fiber optic cable is installed in conduit. Because fiber optic cable is typically 10-20 mm in diameter, it has lower breaking strength and is more easily damaged than a 100 mm twisted pair copper cable. Conduit offers needed protection for fiber optic cable as well as other cables. For convenience of description the term “cable” is used herein to refer to all such copper or fiber optic cables and wires.

### BACKGROUND OF THE INVENTION

Commonly, bushings are either threaded on or held on with friction at the ends of conduits to protect wires and cables as they are pulled through the conduit. More particularly, such bushings protect the wires and cables being pulled from damage as the wire or cable passes the axial extremity of the conduit. Any sharp edge of the axial extremity of the conduit can damage the insulation on the wire or cable and the resulting damage may be very difficult to find and repair deep within the conduit. In some cases the installers have used duct tape to cover the axial extremity of the conduit to prevent the entrance of foreign objects (including construction debris) into the conduit that would interfere with the passage of the wire or cable or that would damage the wire or cable. Such approaches do not provide an adequately secure sealing and inherently must be removed before pulling any cable.

From the above, it is apparent that the maintenance of the integrity of the conduit including the exclusion of foreign objects that would damage the power or data cables or obstruct cable pulling is of great importance. For example, a foreign object in a conduit might require digging up a road or a major structural change to a building. Thus, there exists a need in the art to overcome the deficiencies and limitations described herein and above.

### SUMMARY OF THE INVENTION

The shortcomings of the prior art are overcome and additional advantages are provided through a conduit bushing for cooperation with an associated elongated housing for physical protection of associated telecommunications and/or electric power transmission conductors which includes a generally cylindrical body dimensioned and configured for engagement with the axial extremity of the associated elongated housing. The generally cylindrical body has a peripheral region and a central region. The central region is bounded by the peripheral region. The central region is dimensioned and configured to break away from the peripheral region.

In some embodiments the conduit bushing further includes an appendage attached to the central region to facilitate separation of the central region from the peripheral region. The appendage may be a ring. The central region may be manufactured of a material that allows bending without fracture and may include a slot in the central region for passage of an associated pull string. The slot may have an X-shape.

All embodiments of the conduit bushing may have a generally cylindrical body is dimensioned and configured for engagement with a circular housing.

Accordingly, it is an object of the present invention to protect the integrity of conduits by preventing the intrusion of debris through the axial extremity of the conduit.

It is another object of the present invention to provide apparatus that will protect a conduit from debris throughout the cable pulling process.

It is a still further object of the present invention to provide apparatus that does not need to be removed before pulling any cable.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention. Those skilled in the art will understand that the devices and methods specifically described herein and illustrated in the accompanying drawings are non-limiting exemplary embodiments. The features illustrated or described in connection with one exemplary embodiment can be combined with the features of other embodiments. Such modifications and variations are intended to be included within the scope of the present invention.

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a front view of an embodiment of the present invention,

FIG. 2 is a top view of the same embodiment of the present invention,

FIG. 3 is a side view of the same embodiment of the present invention,

FIG. 4 is a cross section of the same embodiment of the present invention taken along the line 4-4 of FIG. 1,

FIG. 5 is a bottom view of the same embodiment of the present invention.

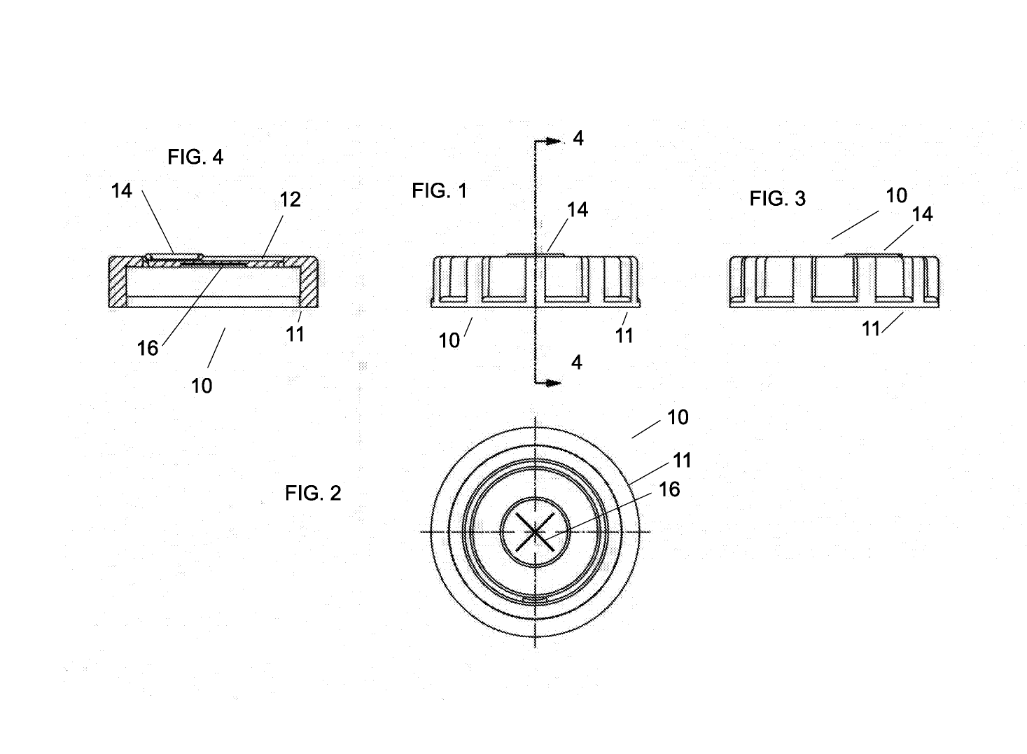

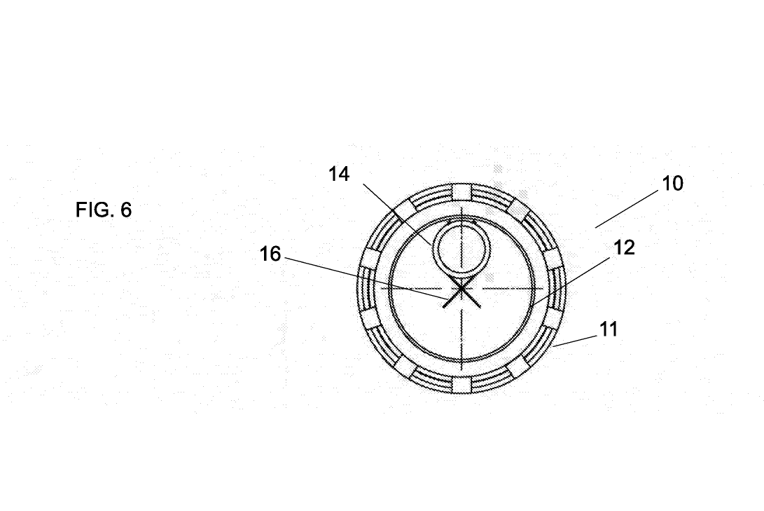

### DETAILED DESCRIPTION

The conduit guard in accordance with the present invention is a conduit bushing to protect the insulation on conductors and/or the protective covering on optic cable as well as preventing the entry of debris into the conduit. The illustrated embodiment of the apparatus 10 includes a cylindrical body 11 with a membrane 12 spanning the circular opening defined by the cylindrical body 11. The membrane preferably has a smaller cross section than the cylindrical body 11. Ordinarily, the cylindrical body 11 and the membrane are injection molded as one piece. Some embodiments may be manufactured by 3D printers. The bushing 10 is secured to an axial extremity of a conduit by either helical threads or frictional engagement. The bushing 10 in accordance with the present invention will protect the cables at all times including times when cable pulling occurs in addition to preventing debris from entering the conduit. This is important because substantial time may occur between installation of the conduit and the pulling of cables in the conduit. Ordinarily, the present apparatus is secured to the axial extremity of the conduit as soon as installation of the conduit is complete.

The apparatus 10 also includes a removable membrane 12 extending across the outer open end of the cylindrical housing 11. The membrane 12, when in place, will prevent any debris from entering the conduit. The membrane 12 is easily and quickly removed by simply peeling the membrane 12 with a circular tab 14 that is part of the membrane 12. In addition the membrane 12 has an “X” punch out or slot 16 to allow a pull string (not shown) to pass through prior to removal of the membrane 12. The cooperation between the circular tab 14 and the membrane 12 is somewhat similar to a so-called pop top soda can. In the soda can the ring removes a section of the can top that allows the passage of liquid sufficient to enable the user to drink. In the present apparatus the membrane 12 will fracture at the entire peripheral part of the membrane 12 that is secured to the much stronger cylindrical housing 11.

Typically, the user will insert a string (not shown) through the X-shaped slot 16 in the membrane 12. In some cases the user may utilize a shop vacuum or other compressed air with a light weight object to move the string through the conduit. The Porta-Blower System manufactured by Greenlee a Textron Company is one such commercially available product. The X-shaped slot allows the user to pull cables without removing the membrane 12. Accordingly, the protection of the conduit from debris continues throughout the cable pulling process.

As previously noted the term conduit as used herein includes ducts for protection of conductors including fiber optic products and the insulation or other protective covering thereon. In embodiments for such ducts the apparatus will have a shape that conforms to the geometry of the duct. Thus, embodiments of the present invention will have a generally rectangular shape for rectangular ducts. Similarly, the duct may be a polygon for which embodiments of the present invention will have an interface to the duct is also a polygon. For convenience of description the description of the preferred embodiment refers to a cylindrical contour, however, those skilled in the art will recognize that the term “cylindrical” as used herein comprehends all such conduit and duct shapes.

More particularly the definition of cylindrical as used herein includes a closed loop bounded by first and second generally parallel spaced apart planes. Thus, the closed-loop may have multiple circumferential parts and any one of those parts may have the shape of any part of a regular polygon, an irregular polygon, a rectangle, a square or other shape having rectilinear or curvilinear contours. The primary consideration is that the bushing have a shape that will engage the axial extremity of the conduit or duct.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A conduit bushing for cooperation with an associated elongated housing for physical protection of associated telecommunications and/or electric power transmission conductors which comprises:
a generally cylindrical body dimensioned and configured for engagement with the axial extremity of the associated elongated housing;
said generally cylindrical body having a peripheral region and a central region, said central region being bounded by said peripheral region, said central region being dimensioned and configured to break away from said peripheral region.

2. A conduit bushing as described in claim 1 further including an appendage attached to said central region to facilitate separation of said central region from said peripheral region.

3. A conduit bushing as described in claim 2 wherein said appendage is a ring.

4. A conduit bushing as described in claim 1 wherein said central region is manufactured of a material that allows bending without fracture.

5. A conduit bushing as described in claim 4 further including a slot in said central region for passage of an associated pull string.

6. A conduit bushing as described in claim 5 wherein said slot has an X-shape.

7. A conduit bushing as described in claim 1 wherein said generally cylindrical body is dimensioned and configured for engagement with a circular housing.

8. A conduit bushing as described in claim 2 wherein said generally cylindrical body is dimensioned and configured for engagement with a circular housing.

9. A conduit bushing as described in claim 3 wherein said generally cylindrical body is dimensioned and configured for engagement with a circular housing.

10. A conduit bushing as described in claim 4 wherein said generally cylindrical body is dimensioned and configured for engagement with a circular housing.

11. A conduit bushing as described in claim 5 wherein said generally cylindrical body is dimensioned and configured for engagement with a circular housing.

12. A conduit bushing as described in claim 6 wherein said generally cylindrical body is dimensioned and configured for engagement with a circular housing.
